(19) United States
(12) Patent Application Publication
(10) Pub. No.: US 2023/0171843 A1
(43) Pub. Date: Jun. 1, 2023

(54) SYSTEMS AND METHODS FOR VEHICLE-TO-EVERYTHING SIDELINK COMMUNICATION

(71) Applicant: ZTE CORPORATION, Shenzhen (CN)

(72) Inventors: Wei LUO, Shenzhen (CN); Lin CHEN, Shenzhen (CN); Boyuan ZHANG, Shenzhen (CN)

(21) Appl. No.: 18/104,343

(22) Filed: Feb. 1, 2023

Related U.S. Application Data
(63) Continuation of application No. PCT/CN2020/107472, filed on Aug. 6, 2020.

(51) Int. Cl. H04W 76/28; H04W 68/00

(52) U.S. Cl. CPC H04W 76/28; H04W 68/005; H04W 92/18

(57) ABSTRACT

Systems and methods for wireless communications are disclosed herein. In some embodiments, a method includes determining, by a first wireless communication device, Sidelink Discontinuous Reception configuration using Sidelink Discontinuous Reception configuration information and communicating, by the first wireless communication device with a second communication device, based on the Sidelink Discontinuous Reception configuration.

### CROSS-REFERENCE TO RELATED APPLICATION

This application claims the benefit of priority under 35 U.S.C. § 120 as a continuation of International Patent Application No. PCT/CN2020/107472, filed on Aug. 6, 2020, the disclosure of which is incorporated herein by reference in its entirety.

### TECHNICAL FIELD

The disclosure relates generally to wireless communications and, more particularly, to systems and methods for V2X communication indicating potential sidelink slots.

### BACKGROUND

Sidelink (SL) communication is a wireless radio communication directly between two or more user equipment devices (hereinafter “UE”). In this type of communication, two or more UEs that are geographically proximate to each other can directly communicate without going through an eNode or a base station (hereinafter “BS”), or a core network. Data transmission in SL communications is thus different from typical cellular network communications, which transmit data to a BS (i.e., uplink transmissions) or receive date from a BS (i.e., downlink transmissions). In SL communications, data is transmitted directly from a source UE to a target UE through the Unified Air Interface, e.g., PC5 interface, without passing through a BS

In within network coverage, all UEs are within network coverage of the BS. In partial network coverage, at least one UE is within network coverage and at least another UE is outside of network coverage. In out of network coverage, all UEs are outside of network coverage.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

In some arrangements, a User Equipment (UE) determines Sidelink (SL) Discontinuous Reception (DRX) configuration using SL DRX configuration information and communicates with a peer UE based on the SL DRX configuration.

In some arrangements, a peer UE receives from another UE a SL DRX configuration and transmits a SL DRX configuration response to the other UE. The SL DRX configuration response includes one of a DRX adjustment request, which indicates that a number of packet loss exceeds a threshold, or a packet loss indication.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a diagram illustrating an example wireless communication network, according to various arrangements.

FIG. 1B is a diagram illustrating a block diagram of an example wireless communication system for transmitting and receiving downlink, uplink, and/or sidelink communication signals, according to various arrangements.

FIG. 2 illustrates an example scenario for sidelink communication, according to various arrangements.

FIG. 3 is a flow diagram illustrating an example process of determining sidelink discontinuous reception configuration, according to various arrangements

FIG. 4 is a flow diagram illustrating an example process of determining sidelink discontinuous reception configuration, according to various arrangements.

FIG. 5 is a flow diagram illustrating an example method for determining sidelink discontinuous reception configuration for wireless communication devices in groupcast, according to various arrangements.

FIG. 6 is a flowchart diagram illustrating an example method for sidelink communication between a first wireless communication device and a second wireless communication device, according to various arrangements.

FIG. 7A is a flowchart diagram illustrating an example wireless communication method for sidelink discontinuous reception configuration, according to various arrangements.

FIG. 7B is a flowchart diagram illustrating an example wireless communication method for sidelink discontinuous reception configuration, according to various arrangements.

FIG. 7C is a flowchart diagram illustrating an example wireless communication method for triggering transmission resource re-selection, according to various arrangements.

FIG. 8A illustrates a block diagram of an example base station, according to various arrangements.

FIG. 8B illustrates a block diagram of an example user equipment, according to various arrangements.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

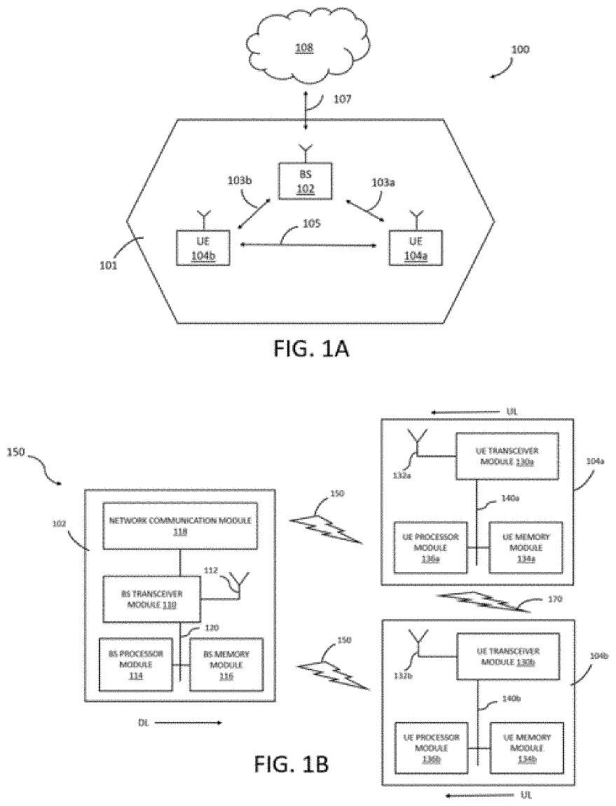

Referring to FIG. 1A, an example wireless communication network 100 is shown. The wireless communication network 100 illustrates a group communication within a cellular network. In a wireless communication system, a network side communication node or a base station (BS) can include a next Generation Node B (gNB), an E-utran Node B (also known as Evolved Node B, eNodeB or eNB), a pico station, a femto station, a Transmission/Reception Point (TRP), an Access Point (AP), or the like. A terminal side node or a user equipment (UE) can include a long range communication system such as, for example, a mobile device, a smart phone, a personal digital assistant (PDA), a tablet, a laptop computer, or a short range communication system such as, for example a wearable device, a vehicle with a vehicular communication system, or the like. In FIG. 1A, a network side and a terminal side communication node are represented by a BS 102 and a UE 104a or 104b, respectively, and in the embodiments in this disclosure hereafter. In some embodiments, the BS 102 and UE 104a/104b are sometimes referred to as “wireless communication node” and “wireless communication device,” respectively. Such communication nodes/devices can perform wireless and/or wired communications.

In the illustrated embodiment of FIG. 1A, the BS 102 can define a cell 101 in which the UEs 104a-b are located. The UE 104a can include a vehicle that is moving within a coverage of the cell 101. The UE 104a can communicate with the BS 102 via a communication channel 103a. Similarly, the UE 104b can communicate with the BS 102 via a communication channel 103b. In addition, the UEs 104a-b can communicate with each other via a communication channel 105. The communication channels (e.g., 103a-b) between the UE and the BS can be through interfaces such as an Uu interface, which is also known as Universal Mobile Telecommunication System (UMTS) air interface. The communication channels (e.g., 105) between the UEs can be through a PC5 interface, which is introduced to address high moving speed and high density applications such as, for example, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, such car network communications modes can be collective referred to as Vehicle-to-Everything (V2X) communications. It is appreciated that the communications channels between the UEs can be used in Device-to-Device (D2D) communications while remaining within the scope of the present disclosure. The BS 102 is connected to a core network (CN) 108 through an external interface 107, e.g., an Iu interface.

FIG. 1B illustrates a block diagram of an example wireless communication system 150 for transmitting and receiving downlink, uplink and sidelink (SL) communication signals, in accordance with some embodiments of the present disclosure. The system 150 may include components and elements configured to support known or conventional operating features that need not be described in detail herein. In one embodiment, the system 150 can transmit and receive data symbols in a wireless communication environment such as the wireless communication network 100 of FIG. 1A, as described above.

The system 150 generally includes the BS 102 and UEs 104a-b, as described in FIG. 1A. The BS 102 includes a BS transceiver module 110, a BS antenna 112, a BS memory module 116, a BS processor module 114, and a network communication module 118, each module being coupled and interconnected with one another as necessary via a data communication bus 120. The UE 104a includes a UE transceiver module 130a, a UE antenna 132a, a UE memory module 134a, and a UE processor module 136a, each module being coupled and interconnected with one another as necessary via a data communication bus 140a. Similarly, the UE 104b includes a UE transceiver module 130b, a UE antenna 132b, a UE memory module 134b, and a UE processor module 136b, each module being coupled and interconnected with one another as necessary via a data communication bus 140b. The BS 102 communicates with the UEs 104a-b via one or more of a communication channel 150, which can be any wireless channel or other medium known in the art suitable for transmission of data as described herein.

As would be understood by persons of ordinary skill in the art, the system 150 may further include any number of modules other than the modules shown in FIG. 1B. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a-b to an antenna of the BS 102 is known as an uplink transmission, and a wireless transmission from an antenna of the BS 102 to an antenna of one of the UEs 104a-b is known as a downlink transmission. In accordance with some embodiments, each of the UE transceiver modules 130a-b may be referred to herein as an uplink transceiver, or UE transceiver. The uplink transceiver can include a transmitter and receiver circuitry that are each coupled to the respective antenna 132a-b. A duplex switch may alternatively couple the uplink transmitter or receiver to the uplink antenna in time duplex fashion. Similarly, the BS transceiver module 110 may be herein referred to as a downlink transceiver, or BS transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and 130a-b are coordinated in time such that the uplink receiver is coupled to the antenna 132a-b for reception of transmissions over the wireless communication channel 150 at the same time that the downlink transmitter is coupled to the antenna 112. In some embodiments, the UEs 104a-b can use the UE transceivers 130a-b through the respective antennas 132a-b to communicate with the BS 102 via the wireless communication channel 150. The wireless communication channel 150 can be any wireless channel or other medium known in the art suitable for downlink (DL) and/or uplink (UL) transmission of data as described herein. The UEs 104a-b can communicate with each other via a wireless communication channel 170. The wireless communication channel 170 can be any wireless channel or other medium known in the art suitable for SL transmission of data as described herein.

Each of the UE transceiver 130a-b and the BS transceiver 110 are configured to communicate via the wireless data communication channel 150, and cooperate with a suitably configured antenna arrangement that can support a particular wireless communication protocol and modulation scheme. In some embodiments, the UE transceiver 130a-b and the BS transceiver 110 are configured to support industry standards such as the Long Term Evolution (LTE) and emerging 5G standards, or the like. It is understood, however, that the present disclosure is not necessarily limited in application to a particular standard and associated protocols. Rather, the UE transceiver 130a-b and the BS transceiver 110 may be configured to support alternate, or additional, wireless data communication protocols, including future standards or variations thereof.

The processor modules 136a-b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 114 and 136a-b, respectively, or in any practical combination thereof. The memory modules 116 and 134a-b may be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a-b may be coupled to the processor modules 114 and 136a-b, respectively, such that the processors modules 114 and 136a-b can read information from, and write information to, memory modules 116 and 134a-b, respectively. The memory modules 116 and 134a-b may also be integrated into their respective processor modules 114 and 136a-b. In some embodiments, the memory modules 116 and 134a-b may each include a cache memory for storing temporary variables or other intermediate information during execution of instructions to be executed by processor modules 114 and 136a-b, respectively. Memory modules 116 and 134a-b may also each include non-volatile memory for storing instructions to be executed by the processor modules 114 and 136a-b, respectively.

The network interface 118 generally represents the hardware, software, firmware, processing logic, and/or other components of the BS 102 that enable bi-directional communication between BS transceiver 110 and other network components and communication nodes configured to communication with the BS 102. For example, the network interface 118 may be configured to support internet or WiMAX traffic. In a typical deployment, without limitation, the network interface 118 provides an 802.3 Ethernet interface such that BS transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the BS 102 to communicate with other BSs or core network over a wired or wireless connection.

In some embodiments, each of the UEs 104a-b can operate in a hybrid communication network in which the UE communicates with the BS 102, and with other UEs, e.g., between 104a and 104b. As described in further detail below, the UEs 104a-b support SL communications with other UE's as well as downlink/uplink communications between the BS 102 and the UEs 104a-b. In general, the SL communication allows the UEs 104a-b to establish a direct communication link with each other, or with other UEs from different cells, without requiring the BS 102 to relay data between UEs.

With the technological advancement and development in the automation industry, the scenarios for V2X communications are further diversified and require higher performance. These advanced V2X service include vehicle platooning, extended sensors, advanced driving (semi-automated driving and full-automated driving), and remote driving. The desire performance requirements may include supporting data packets with a size between 50 to 12,000 bytes, enabling a transmission rate between 2 and 50 messages per second, enabling a maximum end-to-end delay between 3 and 500 milliseconds, supporting a reliability between 90 and 99.999%, enabling a data rate between 0.5 and 1000 Mbps, and supporting a transmission range between 50 and 1000 meters.

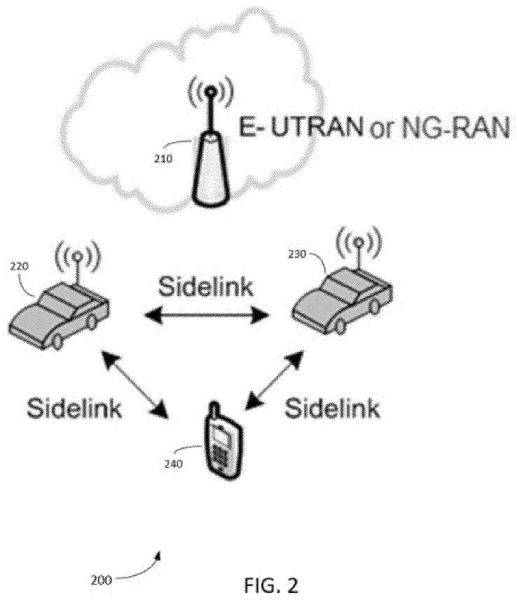

FIG. 2 is a diagram illustrating an example system 200 for SL communication, according to various arrangements. As shown in FIG. 2, a BS 210 (such as BS 102 of FIG. 1A) broadcasts a signal that is received by a first UE 220, a second UE 230, and a third UE 240. UEs 220 and 230, in FIG. 2, are shown as vehicles with vehicular communication networks, while UE 240 is shown as a mobile device. As shown by the SLs, the UEs 220-240 are able to communicate with each (i.e., directly transmit) via an air interface without forwarding by the base station 210 and core network. This type of V2X communication is referred to as PC5-based V2X communication or V2X SL communication, and is one of the manners of implementing the V2X standard from the V2X communication research of 3^{rd} Generation Partnership Project (3GPP)

Various identities can be used for New Radio (NR) SL communication. A first identity is Source Layer-2 Identity (ID), which identifies the sender of the data in NR SL communication. The Source Layer-2 ID is 24 bits long and is split in the Media Access Control (MAC) layer into two bit strings. The first bit string is the Least Significant Bit (LSB) part of Source Layer-2 ID, which is 8 bits long and forward to the physical layer of the sender. This bit string identifies the source of the intended data in sideline control information and is used for filtering packets at the physical layer of the receiver. The second bit string is the Most Significant Bit (MSB) part of the Source Layer-2 ID, which is 16 bits long and is carried within the MAC header. This bit string is used for filtering packets at the MAC layer of the receiver.

A second identity is the Destination Layer-2 ID, which identifies the target of the data in NR SL communication. For NR SL communication, the Destination Layer-2 ID is 24 bits long and is split in the MAC layer into two bit strings. The first bit string is the LSB part of Destination Layer-2 ID, which is 16 bits long and is forwarded to the physical layer of the sender. This bit string identifies the target of the intended data in SL control information and is used for filtering packets at the physical layer of the receiver. The second bit string is the MSB part of the Destination Layer-2 ID, which is 8 bits long and is carried within the MAC header. This bit string is used for filtering packets at the MAC layer of the receiver.

A third identity is the PC5 Link Identifier, which uniquely identifies the PC5 unicast link in a UE for the lifetime of the PC5 unicast link, as specified in TS 23.287 [40]. The PC5 Link Identifier is used to indicate the PC5 unicast link whose SL Radio Link Failure (RLF) declaration was made and whose PC5-RRC (Radio Resource Control) connection was released.

In order for SL communication between UE to work efficiently, a properly configured SL Discontinuous Reception (DRX) is important. Once a first UE determinates a SL DRX configuration, the first UE is able to communicate with a second UE based on the SL DRX configuration. This SL DRX configuration can be determined according to several embodiments.

In a first embodiment, the BS considers PO alignment when configuring SL DRX. By definition, the UE monitors one Paging Occasion (PO) per DRX cycle. A PO is a set of Physical Downlink Control Channel (PDCCH) monitoring occasions and can consist of multiple time slots (e.g., subframe or Orthogonal Frequency Division Multiplexing (OFDM) symbol) in which paging Downlink Control Information (DCI) can be sent. The BS can indicate whether to align with PO when configuring SL DRX of an RRC idle state UE. If the UE receives information indicating SL DRX alignment, the SL-on duration of the UE is the same as the paging occasion.

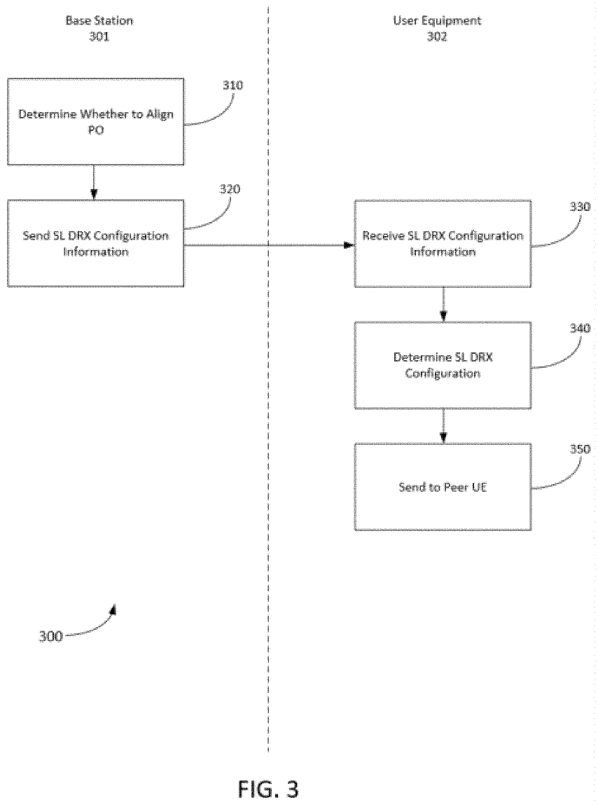

FIG. 3 is a flow diagram showing an example process 300 of determining SL DRX configuration, according to various arrangements. At 310, the BS 301 determines whether to align the PO when configuring the SL DRX of RRC idle state UE. At 310, the BS 301 sends SL DRX configuration information to the UE 302. The SL DRX configuration information includes an SL DRX alignment indication. This SL DRX configuration information is signaled in SystemInformationBlockType1 (SIB1). At 330, the UE 302 receives the SL DRX configuration information. At 340, the UE determines a SL DRX configuration based on the SL DRX configuration information and DL DRX parameters, which include Ns (which is a number of PO in a Paging Frame (PF)), nAndPagingFrameOffset (which is a PF parameter), and the length of the default DRX cycle. A System Frame Number (SFN) for the PF can be determined according to the following formulae:

$$( S F N + P {F}_{offset} ) mod T = ( {UE}_{ID} mod N ) \qquad ( 1 )$$

$${i}_{S} = floor ( \frac{{UE}_{ID}}{N} ) mod {N}_{S} \qquad ( 2 )$$

where T is a DRX cycle of the UE, N is a number of total paging frames in T, Ns could also be a number of DRX-on occasions for a DRX-on frame, PF_{offset} is an offset value used for PF determination, and UE_{ID} is equal to 5G-S-TMSI mod 1024. The values for N and PF_{offset} are derived from the parameter nAndPagingFrameOffset, while T is the length of the default DRX cycle.

Because the SL DRX alignment indication is received, the UE assumes that no DRX is used for the PO. The SL DRX alignment indication indicates that an SL-on duration of the UE is the same as the PO determined by the UE based on the DL DRX parameters. If the DRX is not activated, the UE must continuously monitor for information. The DRX enables sleep or ‘off,’ so no DRX means that the UE is not allowed to sleep. Moreover, after the UE receives the SL DRX configuration information, the UE can inform peer UE of the UE's own SL DRX configuration. The peer UE also need to know the PO, so the UE sends the PO to the peer UE at 350, which can be accomplished in one of two ways. First, the SL DRX configuration may not only include the above received DL DRX parameters (e.g., Ns, nAndPagingFrameOffset, and the length of default DRX cycle) but also includes the UE's own UE_{ID} (i.e., 5G-S-TMSI mod 1024). Second, the SL DRX configuration may include one or more of T, PF_{offset}, DRX_{offset} (which is given by Formula 1), and is (which is given by Formula 2).

In a second embodiment, the BS configures SL DRX patterns for a UE without considering alignment, as alignment is situational and depends on UE capability, meaning alignment may not be best for some UEs. In this embodiment, the BS configures SL DRX patterns for UE according to the configuration of a SL resource pool. The BS determines SL DRX configuration information, which includes slot_{Offset} and a length of the default DRX cycle. The SL DRX configuration information is signaled in SIB1. The UE receives the SL DRX configuration information and determines the SL DRX-on duration according to one of the following formulae:

(Slot_{index}+Slot_{offset})mod T=UE_{ID})mod T (3)

where T is the SL DRX cycle of the UE, slot_{offset} is an offset used for PF determination, UED is one of 5G-S-Temporary Mobile Subscriber Identity (TMSI) mod 1024, destination_{ID} mod 1024, or source_{ID} mod 1024;

(Slot_{index}+Slot_{offset})mod T=Destination_{ID} mod T (4)

or

(Slot_{index}+Slot_{offset})mod T=Source_{ID} mod T (5)

where T is the SL DRX cycle of the UE and slot_{Offset} is an offset used for PF determination. For formulae 4 and 5, the UE may configure different SL DRX configuration for different PC5 link if the UE is involved in multiple PC5 link. Different PC5 links may be associated to different Source_{ID} and Destination_{ID}. Moreover, once the UE has received the SL DRX configuration information, the UE can inform peer UE of the UE's own SL DRX configuration and includes the Slot_{Offset} and the length of a default DRX cycle. The UE informs peer UE of the SL DRX configuration over PC5 RRC message or PC5 broadcast message.

In a third embodiment, the BS configures SL DRX configuration information for a UE and signals the information in SIB1. The SL DRX configuration information includes Ns, nAndDRXFrameOffset, and a length of a default SL DRX cycle. The UE receives the SL DRX configuration information and determines the SL DRX-on duration. The SFN for the SL DRX-on duration frame is determined according to the following formula:

$$( SFN + {F}_{offset} ) mod T = ( \frac{T}{N} ) ⋆ ( {UE}_{ID} mod N ) \qquad ( 6 )$$

and the Slot_{Index} indicating a slot of a frame is determined according to the following formula:

$${Slot}_{Index} = floor ( \frac{{UE}_{ID}}{N} ) mod {N}_{S} \qquad ( 7 )$$

where T is SL DRX cycle of the UE, N is a number of total SL DRX frames in T, Ns is a number of DRX on occasions for a DRX-on frame, F_{offset} is an offset used for DRX-on frame determination, UE_{ID} is one of 5G-S-TMSI mod 1024, Destination_{ID} mod 1024, Source_{ID} mod 1024, Destination_{ID}, or Source_{ID}. The values of N and F_{Offset} are derived from the parameter nAndDRXFrameOffset. T is a length of a default SL DRX Cycle. Ns can be a fixed number, such as a total number of a slot for a frame. Moreover, once the UE has received the SL DRX configuration information, the UE can inform peer UE of the UE's own SL DRX configuration and includes the Ns, nAndDRXFrameOffset, and a length of a default SL DRX Cycle. The UE informs peer UE of the SL DRX configuration over PC5 RRC message or PC5 broadcast message.

In a fourth embodiment, the BS configures SL DRX configuration information for a UE and signals the information in SIB1. The SL DRX configuration information includes DRXFrameOffset and a length of a default SL DRX Cycle. The UE receives the SL DRX configuration information and determines the SL DRX-on duration. The SFN for the SL DRX-on duration frame is determined by one of the following formulae:

(SFN+F_{offset})mod T=UE_{ID} mod T (8)

Slot_{Index}, which indicates a slot of a frame, is determined by the following formula:

Slot_{Index}=UE_{ID} mod N (9)

where T is SL DRX cycle of the UE, F_{Offset} is an offset used for PF determination, N is a fixed total number of a slot of a frame, and UE_{ID} is one of 5G-S-TMSI mod 1024, Destination_{ID} mod 1024, Source_{ID} mod 1024, Destination_{ID}, or Source_{ID}. The UE may configure different SL DRX configuration for different PC5 link if the UE is involved in multiple PC5 link. Different PC5 link may be associated with different Source_{ID} and Destination_{ID}. Moreover, once the UE has received the SL DRX configuration information, the UE can inform peer UE of the UE's own SL DRX configuration and includes the DRXFrameOffset and a length of a default SL DRX Cycle. The UE may also include the UE's own UE_{ID} (e.g., 5G-S-TMSI mod 1024). The UE informs peer UE of the SL DRX configuration over PC5 RRC message or PC5 broadcast message

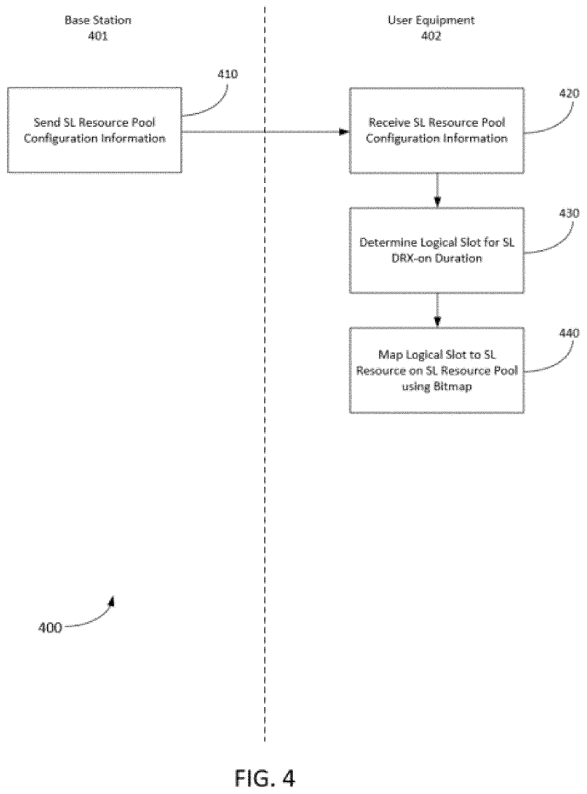

In a fifth embodiment, the SL DRX is configured based on a bitmap that includes a SL resource pool. FIG. 4 is a flow diagram showing an example process 400 of determining SL DRX configuration, according to various arrangements. At 410, the BS 410 transmits SL resource pool configuration information to the UE 402, which is received by the UE 402 at 420. The SL resource pool configuration includes a period (T), offset, and UED. At 430, the UE 402 determines a logical slot for a SL DRX-on duration using the SL DRX configuration information received. At 440, the UE 402 maps the logical slot to a specific SL resource based the bitmap. The mapping may be based on the following formula:

(Slot_{Index}+Slot_{Offset})mod T=UE_{ID} mod T (10)

If the period is 10 units, then the calculated Slot_{Index} is 1, 11, 21 and the corresponding SL resource pool is 1, 11, 21. The slot corresponding to each bitmap is the slot of UE SL DRX-on. In contrast to previous embodiments, the pool of slots is discontinuous, as the bitmap maps to those of the SL resource pool. If a calculated slot index is 2, in this embodiment, the slot index is actually 3 (e.g., 1, 3). Different bitmaps result in different configurations. In this way, different values of T and offset can be configured based on different receiving resource pools. Additionally, a unified (i.e., aligned) T and offset can be configured. If the relationship between T and a period of the resource pool is not an integer multiple, starting position alignment can cause problems that complicate the determination of SL DRX configuration. As such, the relationship between T and the period of resource pool should only be considered if it is an integer multiple.

For sidelink groupcast or broadcast connection (as opposed to uni-cast connection of the first through fifth embodiments), the simplest way for UE with an energy-saving requirement is not to monitor multicast or broadcast messages, but to send multicast and broadcast messages. Because groupcast messages support feedback, even if the UE does not need to listen for groupcast messages, the UE at least needs to listen for feedback messages. If the UE is configured with SL DRX, the RTT timer of the related process can be started after the groupcast message is sent. However, considering that the position of an Acknowledgement (ACK) feedback resource is fixed, an RTT timer is not necessary. As such, SL DRX is not necessary if the receiving scenarios of broadcast and groupcast are not considered.

However, if groupcast and broadcast messages are to be considered with a goal of energy-saving, three solutions are possible. In a first solution, a UE sends the UE's own SL DRX configuration to peer UE through PC5 broadcast message. In a second solution, the UE determines multiple sets of SL DRX configurations corresponding to different destination identifier lists. These SL DRX configurations include one or more of a period (i.e., T), at least one of Slot_{Offset}, F_{Offset}, or DRXFrameOffset, inactivity timers, different re-transmission timers. In a third solution, the UE determines multiple sets of the SL DRX configuration, based on different SL Quality of Service (QoS). The SL QoS comprises one of Packet Delay Budgets (PDBs), priority levels, reliability levels, QoS-FLOWIDENTITY, SL-PC5 QoS Identifier (PQI), or Packet Error Rate level. In another word, the different SL QoS may be associated to different sets of the SL DRX configuration. In particular, the different SL QoS may be associated to different inactivity timers, to different re-transmission timers, or to different DRX periods. Alternatively, the different SL QoS may be associated to the same RTT timers.

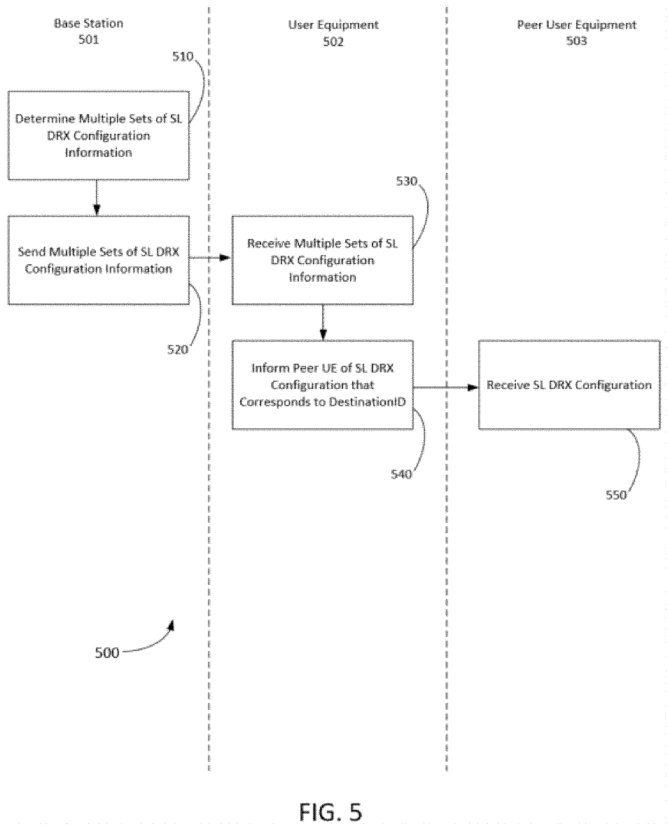

FIG. 5 is a flow diagram illustrating an example method 500 for determining SL DRX configuration for UEs in groupcast, according to various arrangements. At 510, the BS 501 determines multiple sets of SL DRX configuration either based on different SL QoS or that correspond to different Destination_{ID} lists. At 520, the BS 501 sends the multiple sets of SL DRX configuration information to the UE 502, which are received by the UE 502 at 530. At 540, the UE 502 informs Peer UE 503 of the SL DRX configuration that correspond to the Destination_{ID}, which is received by Peer UE 503 at 550. As shown in FIG. 5, Peer UE may be a single UE or may be a plurality of UE, such that the sending of information by the UE 502 at 540 is accomplished via SL groupcast or broadcast message.

If a SL DRX configuration for UE is determined network-side (i.e., by the BS) or is pre-determined, the simplest method for configuration is through the UE. After the UE determines the UE's own SL DRX configuration, the UE informs peer UE, and the peer UE can select transmission resources according to the SL DRX of the original UE. For a UE in uni-cast communication, the UE can inform peer UE of the UE's SL DRX configuration through PC5 RRC message. After obtaining the SL DRX configuration of the receiving UE, the transmitter UE can select the transmitting resource according to the SL DRX pattern of the peer UE.

In a first mode (i.e., mode1), the UE sends the SL DRX configuration information of the peer UE to the service BS so that the service BS can allocate appropriate resources to the receiving UE according to the receiving UE's DRX configuration. Specifically, the UE can report this SL DRX information per Destination ID through SL UE information. In a second mode (i.e., mode2), the UE considers the SL DRX configuration of the receiver UE when selecting resources.

If, after obtaining the SL DRX configuration of the peer UE, the peer UE determines that the available resources will cause data or Channel State Information (CSI) MAC Control Element (CE) timeout, and the SL DRX configurations are inappropriate. In response, the peer UE has two options for a SL DRX configuration response. First, the UE triggers a DRX adjustment request, which indicates a preferred amount of increment for a long DRX cycle length for the current DRX configuration and can be sent through PC5 RRC message or SL MAC CE. This DRX adjustment request may be triggered when the number of packet loss exceeds a threshold(s). If the SL DRX configuration is configured per Destination ID, the number of packet loss can be counted per Destination ID. This threshold is received prior to the SL DRX configuration response transmission. Second, the UE sends an indication of timeout packet loss due to the current DRX configuration. This indication is sent when the number of packet loss per Destination_{ID} exceeds a threshold due to SL DRX configuration. If a value of the threshold is set to 1, then the indication is sent as soon as a single timeout pack loss occurs. This indication information can be carried by SL MAC CE or PC5 RRC transmission, and either indicates only that packet loss has occurred or directly carries the packet loss times or packet loss number level information.

Prior to transmitting the SL DRX configuration response, the peer UE determines that at least one of three conditions are met. First, the peer UE determines that a latency requirement of a data in a logical channel or SL MAC CE is not met due to the SL DRX configuration. Second, the peer UE determines that transmission(s) with a selected SL grant cannot fulfil the latency requirement of the data in a logical channel according to an associated priority due to the SL DRX configuration. Third, the peer UE determines that transmission of a pending SL MAC CE with the sidelink grant(s) cannot fulfil the latency requirement associated to the SL MAC CE due to the SL DRX configuration.

In some embodiments, the peer UE maintains a pack loss number counter. If the peer UE determines that the transmission with a selected SL grant cannot fulfill a latency requirement of data in a logical channel due to the SL DRX configuration, and the pack loss number counter does not reach the threshold, the peer UE adds one to the pack loss number counter. If the pack loss number counter reaches the threshold, the peer UE transmits the SL DRX configuration response, which may be either a DRX adjustment request or an indication of timeout packet loss due to the current DRX configuration. If the UE receives an updated SL DRX configuration of the peer UE, the peer UE either re-initializes the pack loss number counter to zero or sets the pack loss number counter to 0 or 1.

For an embodiment, the peer UE receives SL DRX configuration from the UE. If the peer UE determines that at least transmission with a selected SL grant cannot fulfill a latency requirement of data in a logical channel according to an associated priority due to the received SL DRX configuration, the peer UE may also trigger a transmission resource re-selection.

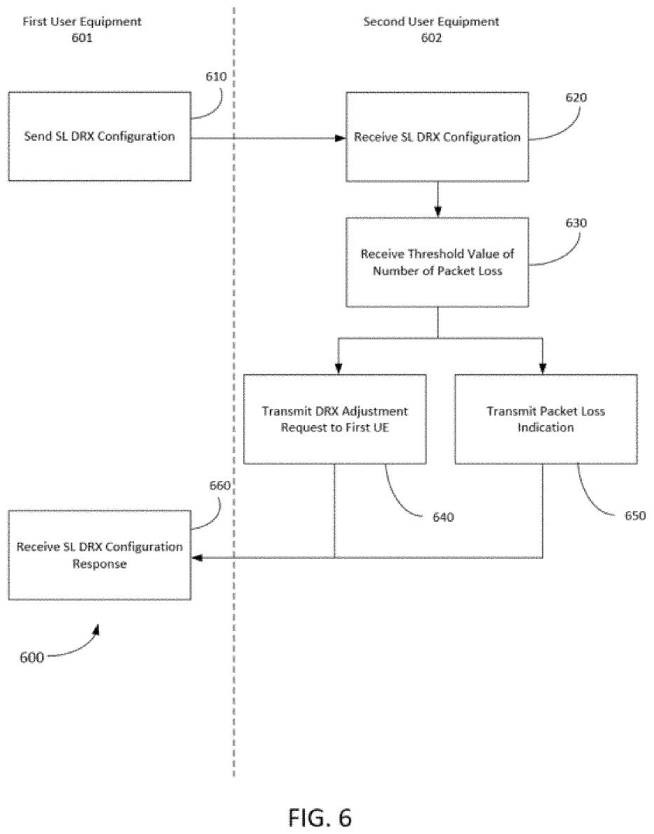

FIG. 6 is a flowchart diagram illustrating an example method 600 for SL communication between a first UE 601 and a second UE 602, according to various arrangements. At 610, the first UE 601 sends SL DRX configuration to the second UE 602, which is received by UE 602 at 620. At 630, the second UE receives a threshold value (or values) of a number of packet loss (or number of packet loss per Destination_{ID}). Then, the second UE 602 transmits one of two SL configuration responses. At 640, the second UE 602 transmits a DRX adjustment request to the first UE 601 indicating that a number of packet loss exceeds the threshold received at 630. At 650, the second UE 602 transmits an indication of packet loss to the first UE. At 660, the first UE receives the SL configuration response (either from 640 or 650).

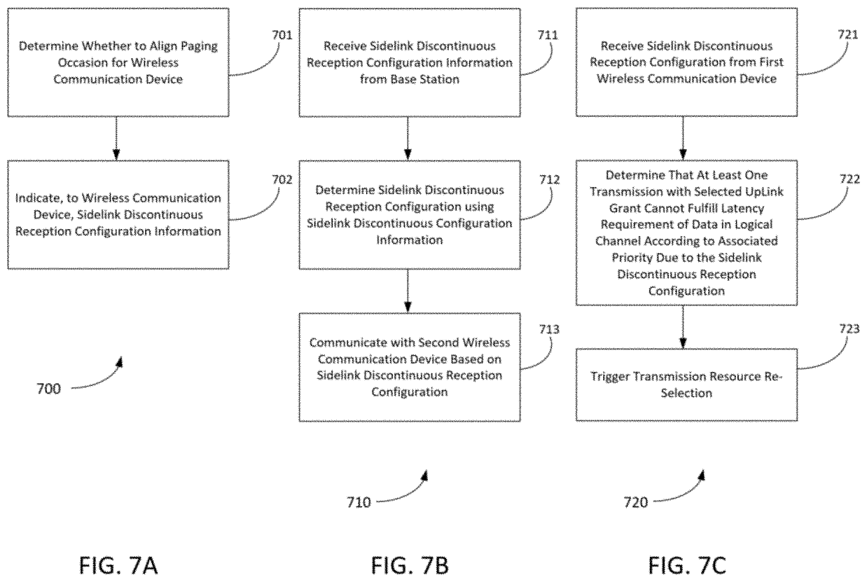

FIG. 7A is a flowchart diagram illustrating an example wireless communication method 700 for SL DRX configuration, according to various arrangements. Referring to FIGS. 1-5, the method 700 can be performed by a BS. Method 700 begins at step 701 where the BS determines whether to align the PO for connected wireless communication devices (e.g., UEs). Then, at step 702, the BS indicates, to the UE, SL DRX configuration information.

FIG. 7B is a flowchart diagram illustrating an example wireless communication method 710 for SL DRX configuration, according to various arrangements. Referring to FIGS. 1-6, the method 710 can be performed by a first UE. The method 710 begins at step 711, where the first UE receives, from a BS, SL DRX configuration information. At step 712, the first UE determines SL DRX configuration using the SL DRX configuration information. Then, at step 713, the UE communicates with a second UE based on the SL DRX configuration.

FIG. 7C is a flowchart diagram illustrating an example wireless communication method 720 for triggering transmission resource re-selection, according to various arrangements. Referring to FIGS. 1-6, the method 720 can be performed by a second UE. The method 720 begins at step 721, where the second UE receives SL DRX configuration from a first UE. At step 722, the peer UE determines that at least one transmission with a selected UL grant cannot fulfill a latency requirement of data in a logical channel according to associated priority due to the SL DRX configuration. Then, at step 713, the second UE triggers transmission resource re-selection.

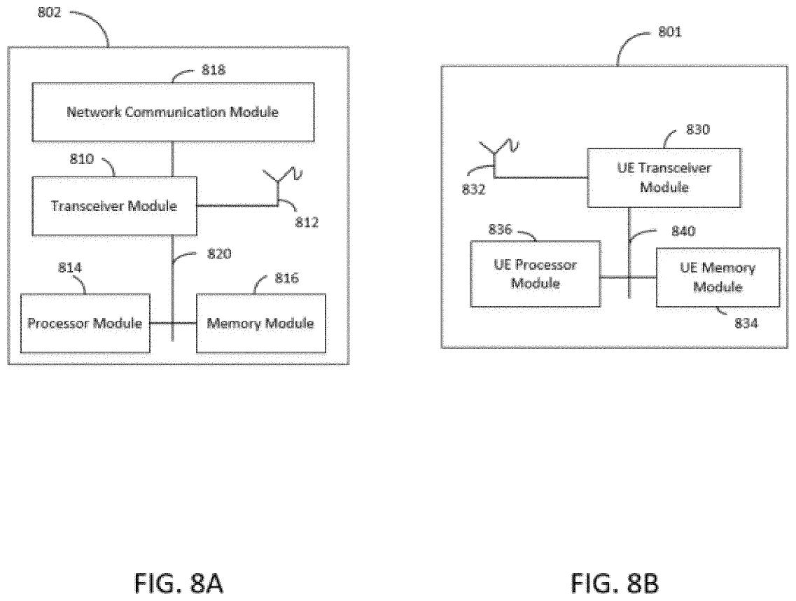

FIG. 8A illustrates a block diagram of an example BS 802, in accordance with some embodiments of the present disclosure. FIG. 8B illustrates a block diagram of an example UE 801, in accordance with some embodiments of the present disclosure. Referring to FIGS. 1-8B, the UE 801 (e.g., a wireless communication device, a terminal, a mobile device, a mobile user, and so on) is an example implementation of the UEs described herein, and the BS 802 is an example implementation of the BS described herein.

The BS 802 and the UE 801 can include components and elements configured to support known or conventional operating features that need not be described in detail herein. In one illustrative embodiment, the BS 802 and the UE 801 can be used to communicate (e.g., transmit and receive) data symbols in a wireless communication environment, as described above. For instance, the BS 802 can be a BS (e.g., gNB, eNB, and so on), a server, a node, or any suitable computing device used to implement various network functions.

The BS 802 includes a transceiver module 810, an antenna 812, a processor module 814, a memory module 816, and a network communication module 818. The module 810, 812, 814, 816, and 818 are operatively coupled to and interconnected with one another via a data communication bus 820. The UE 801 includes a UE transceiver module 830, a UE antenna 832, a UE memory module 834, and a UE processor module 836. The modules 830, 832, 834, and 836 are operatively coupled to and interconnected with one another via a data communication bus 840. The BS 802 communicates with the UE 801 or another BS via a communication channel, which can be any wireless channel or other medium suitable for transmission of data as described herein.

As would be understood by persons of ordinary skill in the art, the BS 802 and the UE 801 can further include any number of modules other than the modules shown in FIGS. 8A and 8B. The various illustrative blocks, modules, circuits, and processing logic described in connection with the embodiments disclosed herein can be implemented in hardware, computer-readable software, firmware, or any practical combination thereof. To illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. The embodiments described herein can be implemented in a suitable manner for each particular application, but any implementation decisions should not be interpreted as limiting the scope of the present disclosure.

In accordance with some embodiments, the UE transceiver 830 includes a radio frequency (RF) transmitter and a RF receiver each including circuitry that is coupled to the antenna 832. A duplex switch (not shown) may alternatively couple the RF transmitter or receiver to the antenna in time duplex fashion. Similarly, in accordance with some embodiments, the transceiver 810 includes an RF transmitter and a RF receiver each having circuitry that is coupled to the antenna 812 or the antenna of another BS. A duplex switch may alternatively couple the RF transmitter or receiver to the antenna 812 in time duplex fashion. The operations of the two-transceiver modules 810 and 830 can be coordinated in time such that the receiver circuitry is coupled to the antenna 832 for reception of transmissions over a wireless transmission link at the same time that the transmitter is coupled to the antenna 812. In some embodiments, there is close time synchronization with a minimal guard time between changes in duplex direction.

The UE transceiver 830 and the transceiver 810 are configured to communicate via the wireless data communication link, and cooperate with a suitably configured RF antenna arrangement 812/832 that can support a particular wireless communication protocol and modulation scheme. In some illustrative embodiments, the UE transceiver 830 and the transceiver 810 are configured to support industry standards such as the Long Term Evolution (LTE) and emerging 5G standards, and the like. It is understood, however, that the present disclosure is not necessarily limited in application to a particular standard and associated protocols. Rather, the UE transceiver 830 and the BS transceiver 810 may be configured to support alternate, or additional, wireless data communication protocols, including future standards or variations thereof.

The transceiver 810 and the transceiver of another BS (such as but not limited to, the transceiver 810) are configured to communicate via a wireless data communication link, and cooperate with a suitably configured RF antenna arrangement that can support a particular wireless communication protocol and modulation scheme. In some illustrative embodiments, the transceiver 810 and the transceiver of another BS are configured to support industry standards such as the LTE and emerging 5G standards, and the like. It is understood, however, that the present disclosure is not necessarily limited in application to a particular standard and associated protocols. Rather, the transceiver 810 and the transceiver of another BS may be configured to support alternate, or additional, wireless data communication protocols, including future standards or variations thereof.

In accordance with various embodiments, the BS 802 may be a BS such as but not limited to, an eNB, a serving eNB, a target eNB, a femto station, or a pico station, for example. The BS 802 can be an RN, a DeNB, or a gNB. In some embodiments, the UE 801 may be embodied in various types of user devices such as a mobile phone, a smart phone, a personal digital assistant (PDA), tablet, laptop computer, wearable computing device, etc. The processor modules 814 and 836 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the method or algorithm disclosed herein can be embodied directly in hardware, in firmware, in a software module executed by processor modules 814 and 836, respectively, or in any practical combination thereof. The memory modules 816 and 834 may be realized as RAM memory, flash memory, ROM memory, EPROM memory, EEPROM memory, registers, a hard disk, a removable disk, a CD-ROM, or any other form of storage medium known in the art. In this regard, memory modules 816 and 834 may be coupled to the processor modules 814 and 836, respectively, such that the processors modules 814 and 836 can read information from, and write information to, memory modules 816 and 834, respectively. The memory modules 816 and 834 may also be integrated into their respective processor modules 814 and 836. In some embodiments, the memory modules 816 and 834 may each include a cache memory for storing temporary variables or other intermediate information during execution of instructions to be executed by processor modules 814 and 836, respectively. Memory modules 816 and 834 may also each include non-volatile memory for storing instructions to be executed by the processor modules 814 and 836, respectively.

The network communication module 818 generally represents the hardware, software, firmware, processing logic, and/or other components of the BS 802 that enable bi-directional communication between the transceiver 810 and other network components and communication nodes in communication with the BS 802. For example, the network communication module 818 may be configured to support internet or WiMAX traffic. In a deployment, without limitation, the network communication module 818 provides an 802.3 Ethernet interface such that the transceiver 810 can communicate with a conventional Ethernet based computer network. In this manner, the network communication module 818 may include a physical interface for connection to the computer network (e.g., Mobile Switching Center (MSC)). In some embodiments, the network communication module 818 includes a fiber transport connection configured to connect the BS 802 to a core network. The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
determining, by a first wireless communication device, Sidelink (SL) Discontinuous Reception (DRX) configuration using SL DRX configuration information; and
communicating, by the first wireless communication device with a second communication device, based on the SL DRX configuration.

2. The method of claim 1, further comprising:
receiving, by the first wireless communication device from a base station, downlink (DL) DRX configuration information and the SL DRX configuration information, wherein the DL DRX configuration information comprises one or more DL DRX parameters;
determining, by the first wireless communication device, the SL DRX configuration using the DL DRX parameters and the SL DRX parameters, wherein
the SL DRX configuration information comprises SL DRX alignment indication, and
the DL DRX parameters comprise one or more of a number of Paging Occasions (POs) for a Paging Frame (PF), a paging frames parameter, a length of a default DRX cycle.

3. The method of claim 2, wherein the SL DRX alignment indication indicates that no DRX is used for a PO determined by the first wireless communication device using the DL DRX parameters.

4. The method of claim 2, wherein the SL DRX alignment indication indicates that an SL on duration of the first wireless communication device is same as a PO determined by the first wireless communication device using the DL DRX parameters.

5. The method of claim 2, further comprising informing, by the first wireless communication device, the SL DRX configuration to the second communication device by:
transmitting, by the first wireless communication device to the second communication device, one or more of the DL DRX parameters and an identifier identifying the first wireless communication device; or
transmitting, by the first wireless communication device to the second communication device, one or more of a DRX cycle of the first wireless communication device, an offset used to determine the PF, a DRX offset, and the index of the PO.

6. The method of claim 1, further comprising:
receiving, by the first wireless communication device from a base station, the SL DRX configuration information, the SL DRX configuration information comprising a slot offset and a length of a default DRX cycle;
determining, by the first wireless communication device, the SL DRX configuration using the SL DRX configuration information, wherein
determining the SL DRX configuration information comprises determining the SL DRX on duration using the slot offset, a length of a DRX cycle and an identifier, wherein the identifier is determined based on one of:
a Temporary Mobile Subscriber Identity (TMSI),
a destination identifier, or
a source identifier.

7. The method of claim 6, further comprising transmitting, by the first wireless communication device to the second communication device, one or more of the slot offset and the length of the default DRX cycle.

8. The method of claim 1, further comprising:
receiving, by the first wireless communication device from a base station, the SL DRX configuration information, the SL DRX configuration information comprising one or more DRX parameters;
determining, by the first wireless communication device, the SL DRX configuration using the DRX parameters, wherein
the DRX parameters comprise one or more of a length of a default SL DRX cycle, a number of total SL DRX frames in the length of the default SL DRX cycle, a number of DRX on occasions for a DRX on frame, and an offset used for determining the DRX on frame;
determining the SL DRX configuration information comprises determining the SL DRX on duration using the DRX parameters;
determining the SL DRX on duration comprises determining a System Frame Number (SFN) and a slot index indicating a slot of DRX on occasions based on the DRX parameters and an identifier, the identifier being determined based on one of:
a Temporary Mobile Subscriber Identity (TMSI),
a destination identifier, or
a source identifier.

9. The method of claim 8, further comprising informing, by the first wireless communication device, the SL DRX configuration to the second communication device by transmitting, by the first wireless communication device to the second communication device, one or more of the DRX parameters.

10. The method of claim 1, further comprising:
receiving, by the first wireless communication device from a base station, the SL DRX configuration information, the SL DRX configuration information comprising one or more DRX parameters;
determining, by the first wireless communication device, the SL DRX configuration using the DRX parameters, wherein
the DRX parameters comprise one or more of a DRX frame offset and a length of a default DRX cycle;
determining the SL DRX configuration information comprises determining the SL DRX on duration using the DRX parameters;
determining the SL DRX on duration comprises determining a System Frame Number (SFN) and a slot index indicating a slot of DRX on occasions based on the DRX parameters and an identifier, the identifier being determined based on one of:
a Temporary Mobile Subscriber Identity (TMSI),
a destination identifier, or
a source identifier.

11. The method of claim 10, further comprising informing, by the first wireless communication device, the SL DRX configuration to the second communication device by transmitting, by the first wireless communication device to the second communication device, one or more of the DRX parameters and the identifier.

12. The method of claim 1, wherein determining the SL DRX configuration comprises:
receiving, by the first wireless communication device from a base station, a SL resource pool configuration information,
determining a logical slot for a SL DRX on duration using the SL DRX configuration information; and
mapping the logical slot to a SL resource in a SL resource pool using a bitmap, wherein the bitmap comprises mapping of logical slots to resources in the SL resource pool.

13. The method of claim 1, wherein the second communication device comprises a plurality of second communication devices, and the method further comprises informing, by the first wireless communication device, a same set of the SL DRX configuration to the second communication devices via SL multicast or broadcast message.

14. The method of claim 1, further comprises one of:
determining multiple sets of the SL DRX configuration, based on different SL Quality of Service (QoS) wherein the SL QoS comprises one of: Packet Delay Budgets (PDBs), priority levels, reliability levels, QoS-FLOWIDENTITY, SL-PC5 QoS Identifier (PQI), or Packet Error Rate level; or
determining the multiple sets of the SL DRX configuration correspond to different destination identifier lists, wherein the SL DRX configuration comprises one or more of a DRX frame offset, a length of a default DRX cycle, inactivity timers, or retransmission timers.

15. The method of claim 14, further comprising receiving, by the first wireless communication device from a base station, multiple sets of the SL DRX configuration information, and each of the QoS or destination identifier lists corresponds to one of the sets of the SL DRX configuration information, wherein the SL DRX configuration comprises at least one of a DRX frame offset, a length of a default DRX cycle, inactivity timers, or retransmission timers.

16. A wireless communication method for Sidelink (SL) communications between a first wireless communication device and a second wireless communication device, comprising:
receiving, by the second wireless communication device from the first wireless communication device, a SL Discontinuous Reception (DRX) configuration;
transmitting, by the second wireless communication device to the first wireless communication device, a SL DRX configuration response, wherein the SL DRX configuration response comprises one of:
a DRX adjustment request, the DRX adjustment request indicating that a number of packet loss exceeds a threshold due to the SL DRX configuration; or
packet loss indication due to the SL DRX configuration.

17. The method of claim 16, further comprising:
prior to transmitting the DRX adjustment request:
determining, by the second wireless communication device, that a latency requirement of data in a logical channel or SL Media Access Control (MAC) Control Element (CE) is not met due to the SL DRX configuration;
determining, by the second wireless communication device, that at least one transmission with a selected SL grant cannot fulfil the latency requirement of the data in a logical channel according to an associated priority due to the SL DRX configuration; or
determining, by the second wireless communication device, that transmission of a pending SL MAC CE with the selected SL grant cannot fulfil the latency requirement associated to the SL MAC CE due to the SL DRX configuration.

18. The method of claim 16, wherein one of
the packet loss indication indicates packet loss having occurred due to the SL DRX configuration, or
the packet loss indication directly carries packet loss times or packet loss number level information.

19. A first wireless communication device, comprising:
at least one processor configured to:
determine Sidelink (SL) Discontinuous Reception (DRX) configuration using SL DRX configuration information; and
communicate, via a transceiver with a second communication device, based on the SL DRX configuration.

20. A second wireless communication device, comprising:
at least one processor configured to:
receive, via a transceiver from a first wireless communication device, a Sidelink (SL) Discontinuous Reception (DRX) configuration;
transmit, via the transceiver to the first wireless communication device, a SL DRX configuration response, wherein the SL DRX configuration response comprises one of:
a DRX adjustment request, the DRX adjustment request indicating that a number of packet loss exceeds a threshold due to the SL DRX configuration; or
packet loss indication due to the SL DRX configuration.
